(19) United States
(12) Patent Application Publication
(10) Pub. No.: US 2005/0258148 A1
(43) Pub. Date: Nov. 24, 2005

(54) Plasma system with isolated radio-frequency powered electrodes

(75) Inventor: Robert S. Condrashoff, Walnut Creek, CA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 10/848,205

(22) Filed: May 18, 2004

(51) Int. Cl. B23K 9/00

(52) U.S. Cl. 219/121.43

(57) ABSTRACT

A plasma system including a plasma source inside a vacuum chamber that is coupled by an electrical circuit with a radio-frequency power supply and an isolation transformer in the electrical circuit. The isolation transformer has a primary coil electrically connected with the radio-frequency power supply and a secondary coil electrically connected with the plasma source. The electrical circuit may include an impedance matching network located between the plasma source and the secondary coil or, alternatively, between the radio-frequency power supply and the primary coil.

### FIELD OF THE INVENTION

This invention relates generally to plasma systems and processing, and more particularly to the electrodes and related equipment used in plasma systems and the methods for powering electrodes in a plasma system.

### BACKGROUND OF THE INVENTION

Plasma systems are commonly used for a wide variety of purposes including modifying the surface properties of workpieces used in various applications, including applications relating to integrated circuits, electronic packages, rectangular glass substrates used in flat panel displays, and printed circuit boards. Exposure of a surface of a substrate or workpiece to a plasma inside a plasma system removes surface atoms by physical sputtering, chemically-assisted sputtering, or chemical reactions. The physical or chemical action is used to condition the surface to improve properties such as adhesion, to selectively remove an extraneous surface layer of a process material, or to clean undesired contaminants from the surface. In electronics packaging applications, exposure to a plasma may be used to increase surface activation and/or surface cleanliness for eliminating delamination and bond failures, improving wire bond strength, ensuring void free underfill, removing oxides, enhancing die attach, and improving adhesion for encapsulation.

Plasma systems are integrated into in-line and cluster systems or batch processes in which groups of workpieces are successively processed. Workpieces are supplied by various methods, including delivery in a magazine, individual delivery by a transport system, or manual insertion into the process chamber. Plasma systems may also be provided with automated robotic manipulators that coordinate workpiece exchange into and out of the process chamber for plasma processing operations.

A conventional plasma system, as shown in FIG. 1, includes a grounded vacuum chamber 10, a radiofrequency (RF) power supply 12 operating at 13.56 MHz, and a matching network 14 located in the electrical path between the vacuum chamber 10 and the RF power supply 12. The RF power supply 12 is used to energize a powered electrode 16, which is positioned with an opposing and parallel relationship with a grounded electrode 18 inside the vacuum chamber 10, for generating a plasma 20. The plasma 20 is distributed over the entire volume of the vacuum chamber 10 with the highest plasma density between the electrodes 16 and 18. A capacitor 22 is placed in series between the RF power supply 12 and the powered electrode 16. The matching network also includes a shunt capacitor 24 to ground and an inductor 26 that cooperate with the series capacitor 22 to help match the impedance of the plasma 20 to the output impedance of the RF power supply 12. The series and shunt capacitors 22, 24 are variable and receive feedback from a phase/mag 28 equipped with sensors that detect the phase and magnitude of the power reflected from the plasma 20.

Conventional plasma systems have failed to provide adequate process uniformity across the surface of individual workpieces positioned between the electrodes 16, 18 due to nonuniformities in the plasma density. One origin of such nonuniformities is the influence of the grounded vacuum chamber 10 on the plasma 20, referred to as external field effects. These external field effects shape the distribution of the constituent charged components of the plasma 20. As a result, the plasma density proximate to the workpiece is nonuniform and produces non-uniformities in the plasma treatment of the workpiece surface. One method of reducing external field effects is to make the vacuum chamber 10 larger so that the grounded sidewalls are more distant from the electrodes 16, 18. However, this has the effect of an increased system footprint and an increased time to evacuate the vacuum chamber 10, which are undesirable effects.

It would therefore be desirable to provide a plasma system in which external field effects due to the chamber sidewall are minimized or eliminated.

### SUMMARY OF THE INVENTION

In accordance with one embodiment of the invention, a plasma system comprises an impedance matching network coupled between a plasma source inside a vacuum chamber and a radio-frequency power supply. The system further includes an isolation transformer having a primary coil electrically connected with the radio-frequency power supply and a secondary coil electrically connected with the plasma source. The presence of the isolation transformer reduces the time for performing typical plasma treatments and improves process uniformity across the surface of a workpiece exposed to the plasma.

In accordance with another embodiment of the invention, a method for improving plasma uniformity in a plasma system that includes a plasma chamber, powered electrodes inside the plasma chamber, and a radio-frequency power supply. The method includes electrically isolating the powered electrodes from the radio-frequency power supply and energizing the powered electrodes with power supplied from the radio-frequency power supply to generate a plasma inside the plasma chamber.

Various objects, advantages and advantages of the invention shall be made apparent from the accompanying drawings of the illustrative embodiment and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagrammatic view of a conventional plasma system in accordance with the prior art;

FIG. 2 is a diagrammatic view of a plasma system in accordance with an embodiment of the invention; and

FIG. 3 is a diagrammatic view of a plasma system in accordance with another embodiment of the invention.

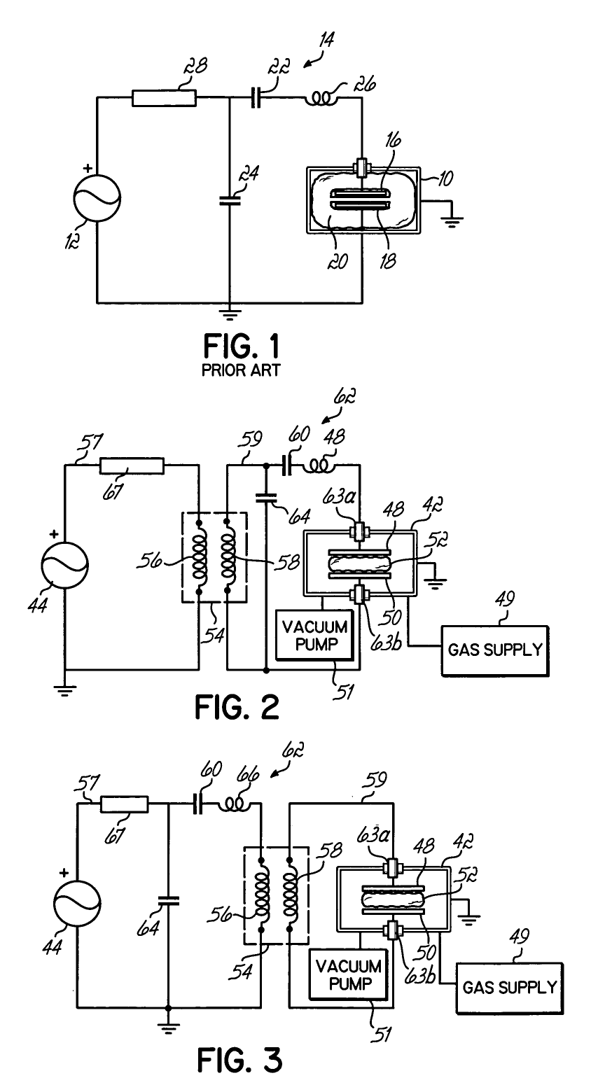

### DETAILED DESCRIPTION OF THE PREFERRED EMBODIMENTS

With reference to FIG. 2, a plasma system 40, in accordance with the principles of the present invention includes a grounded vacuum chamber 42 having electrically conducting sidewalls, a radiofrequency (RF) power supply 44, and an adjustable impedance matching network, generally indicated by reference numeral 46. Impedance network 46 contains circuit elements of an electrical circuit coupling a pair of powered electrodes 48 and 50 with the RF power supply 44. The RF power supply 44 operates at a frequency of, for example, about 13.56 MHz and may supply either single- or mixed-frequency RF power at less than about 600 watts to powered electrodes 48 and 50. The powered electrodes 48 and 50 are positioned with an opposing and substantially parallel relationship inside the vacuum chamber 42.

Powered electrodes 48 and 50 operate as a plasma source within chamber 42 when energized by power supplied from the RF power supply 44, which excites a partial pressure of a suitable source gas enclosed inside the vacuum chamber 42 to generate a plasma 52. The source gas is supplied under mass flow control to the vacuum chamber 42 from a gas supply 49. A vacuum pump 51 is coupled in fluid communication with the vacuum chamber 42 for evacuating the vacuum chamber 42 to a sub-atmospheric pressure. The excited plasma 52 interacts with a workpiece (not shown) positioned between the electrodes 48 and 50 and inside a footprint defined by the peripheral edges of the electrodes 48 and 50. In certain embodiments, plasma system 40 may be any of the in-line systems, including but not limited to the ITRAK™, XTRAK™ and FlexTRAK™ in-line systems, commercially available from March Plasma Systems (Concord, Calif.).

With continued reference to FIG. 2, an isolation transformer 54 is positioned in the electrical circuit between the powered electrodes 48 and 50 and the RF power supply 44. The isolation transformer 54 has a primary winding or coil 56 receiving voltage over a transmission line 57, such as a coaxial cable, from the RF power supply 44 and an electromagnetically-coupled secondary winding or coil 58 that provides an induced voltage over a transmission line 59 to the powered electrodes 48 and 50. One end of the primary coil 56 is electrically coupled with the RF power supply 44 and the other end of the primary coil 56 is electrically coupled with the RF power supply 44 with respect to ground. One end of the secondary coil 58 is electrically coupled with the powered electrode 48 and the other end of the secondary coil 58 is electrically coupled with the powered electrode 50. The isolation transformer 54 provides direct current isolation of the primary coil 56 from the secondary coil 58 and, therefore, direct current isolation of the powered electrodes 50 from the RF power supply 44.

The impedance matching network 46 is electrically coupled between the primary coil 56 and the powered electrodes 48 and 50. Transmission line 57 provides power to electrical feedthroughs 62, 63, each of which presents a current path that is electrically isolated from the vacuum chamber 42. The powered electrodes 48, 50 are electrically coupled with the transmission line 57 through the electrical feedthroughs 62, 63.

The load presented by the powered electrodes 48, 50 is powered by an output voltage from the secondary coil 58. The magnitude of the output voltage is a function of the turns ratio between the primary coil 56 and the secondary coil 58. In one embodiment of the invention, the isolation transformer 54 has a 1:1 ratio between the primary and secondary coils 56, 58 and the RF power supply 44 presents a 50 ohm fixed output impedance to the primary coil 56.

With continued reference to FIG. 2, a series capacitor 60 of the impedance matching network 46 is placed in series between the secondary coil 58 of the isolation transformer 54 and powered electrode 48. The impedance matching network, generally indicated by reference numeral 46, also includes a shunt capacitor 64 coupling the electrodes 48, 50 and an inductor 66 placed in series with capacitor 60 to define a parallel LC circuit. The inductor 66 is characterized by a fixed inductance, and the series and shunt capacitors 60, 64 both have a variable capacitance under the control of a controller (not shown) receiving feedback from a phase/mag 67. The capacitance of the series capacitor 60 is adjustable independent of the capacitance of the shunt capacitor 64.

The phase/mag 67 includes transducers or pickups that measure the phase and amplitude (e.g., RMS voltage, RMS current, peak-to-peak voltage, or peak-to-peak current) of the transferred RF power over time of the reflected power from the plasma 20 back to the RF power supply 44. The phase/mag 67 is located between the primary coil 56 and the RF power supply 44. A control circuit in the controller relies on the feedback information relating to the reflected power and adjusts the variable capacitors 60, 64 to minimize the reflected power. Minimization of the reflected power reduces the RF power wasted by reflection back to the RF power supply 44, as opposed to being delivered to the plasma 52, and minimizes the load on the RF power supply 44 during operation. Adjustments in capacitance may be provided automatically by operation of actuators, such as reversible DC motor drives, coupled with the capacitors 60, 64.

In use and with continued reference to FIG. 2, the vacuum chamber 42 is evacuated to a low pressure and a partial pressure of a plasma source gas is introduced after one or more substrates are placed on a support within a plasma zone defined between the electrodes 48, 50. The electrodes 48, 50 are energized by the RF power supply 44 to create an electric field that generates or energizes process gas in the chamber 42 to form the plasma 52. Subsequently, the RF power from the electrodes 48, 50 is coupled with the plasma 52 for sustaining the discharge. The sidewall of the chamber 42 is not a circuit element. As a result, the electric field is confined to the space between the electrodes 48, 50 and does not fringe outwardly.

The confinement of the electric field causes the source gas between the electrodes 48, 50 to ionize and become a plasma 52 characterized by a considerably higher density than the plasma density in peripheral portions of the chamber 42. The plasma density outside of the region bounded by the electrodes 48, 50 is substantially less than the plasma density between the electrodes 48, 50 and may be negligible in comparison to the plasma density between the electrodes 48, 50. Because the plasma density between the electrodes 48, 50 is free of external field effects arising from the sidewall of chamber 42, the plasma density is substantially more uniform or homogeneous. As a result, process uniformity is improved and the increased plasma density plasma between the electrodes 48, 50 decreases processing time in comparison to conventional plasma systems not equipped with an isolation transformer. The secondary coil 58 is direct current isolated from the RF power supply 44, which reduces or virtually eliminates any direct current potential between the sidewall of the vacuum chamber 42 and the electrodes 48, 50, so that the electric potential of the electrodes 48, 50 is floating with respect to the vacuum chamber 42.

The plasma 52 represents a variable load to the RF power supply 44 as the process conditions changes. The amount of loading is contingent upon, among other parameters, changes in source gas and chamber pressure that affect plasma conditions such as plasma temperature and density. The capacitance of the series and shunt capacitors 60, 64 of the impedance matching network 46 are adjusted to compensate for variations in load impedance due to changes in plasma conditions so as to match the impedance presented by the plasma 52 and electrodes 48, 50 with the output impedance of the RF power supply 44. Impedance matching ensures satisfactory energy transfer from the RF power supply 44 to the plasma 52. Adjusting the capacitance of the series capacitor 60 adjusts the series impedance and adjusting the capacitance of the shunt capacitor 64 adjusts the shunt impedance. The series and shunt capacitors 60, 64 are adjusted in conjunction with each another to realize optimum power transfer from the RF power supply 44 to the plasma 72.

With reference to FIG. 3 in which like reference numerals refer to like features in FIG. 2 and in accordance with an alternative embodiment of the invention, the impedance matching network 46 may be coupled in the electrical circuit between the primary coil of isolation transformer 54 and the radio-frequency power supply 44. As described above with regard to FIG. 2, the primary coil 56 receives voltage from the RF power supply 44 and the secondary coil 58 provides an induced voltage to the powered electrodes 48 and 50. Capacitor 60 is placed in series in the electrical circuit between the secondary coil 58 of the isolation transformer 54 and powered electrode 48. Shunt capacitor 64 extends to ground and an inductor 66 is series with capacitor 60. Powered electrodes 48, 50 are coupled to the secondary coil 58 in the electrical circuit. Phase/mag 67 is located in the electrical circuit between the RF power supply 44 and the primary coil 56. Again, the secondary coil 58 is direct current isolated from the RF power supply 44, which reduces or virtually eliminates any direct current potential between the sidewall of the vacuum chamber 42 and the electrodes 48, 50, so that the electric potential of the electrodes 48, 50 is floating with respect to the vacuum chamber 42.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

1. A plasma system, comprising:
a vacuum chamber;
a plasma source including first and second electrodes arranged with a confronting, substantially parallel relationship inside said vacuum chamber, a radio-frequency power supply; and
an electrical circuit coupling said plasma source with said radio-frequency power supply, said electrical circuit comprising an isolation transformer having a primary coil electrically connected with said radio-frequency power supply and a secondary coil electrically connected with said first and second electrodes.

2. The plasma system of claim 1 further comprising:
an impedance matching network electrically coupled between said primary coil and said radio-frequency power supply.

3. The plasma system of claim 2 wherein said impedance matching network further comprises a parallel LC circuit.

4. The plasma system of claim 1 further comprising:
an impedance matching network electrically coupled between said primary coil and said plasma source.

5. The plasma system of claim 4 wherein said impedance matching network further comprises a parallel LC circuit.

6. (canceled)

7. The plasma system of claim 1 wherein said vacuum chamber includes electrically-conducting walls, and said first and second electrodes are electrically isolated from said walls.

8. The plasma system of claim 1 wherein said plasma source is electrically isolated from said vacuum chamber.

9. A method for improving plasma uniformity in a plasma system having a plasma chamber, a radio-frequency power supply, and powered electrodes inside the plasma chamber, comprising:
electrically isolating the radio-frequency power supply from the powered electrodes; and
energizing the powered electrodes with power supplied from the radio-frequency power supply to generate a plasma inside the plasma chamber.

10. The method of claim 9 further comprising:
matching an impedance of the plasma and the powered electrodes with an output impedance of the radio-frequency power supply.

11. The method of claim 9 wherein energizing the powered electrodes further comprises:
supplying a voltage from the radio-frequency power supply to a primary coil of an isolation transformer,
transferring the supplied voltage as an induced voltage from the primary coil to a secondary coil of the isolation transformer; and
transferring the induced voltage to the powered electrodes.

12. The method of claim 11 further comprising:
electrically coupling an impedance matching network between the primary coil and the radio-frequency power supply.

13. The method of claim 11 further comprising:
electrically coupling an impedance matching network between the secondary coil and the powered electrodes.

14. The method of claim 9 wherein electrically isolating further comprises:
coupling the radio-frequency power supply with a primary coil of an isolation transformer;
coupling the powered electrodes with a secondary coil of the isolation transformer.

15. The method of claim 14 wherein energizing the powered electrodes further comprises:
supplying a voltage from the radio-frequency power supply to the primary coil;
transferring the supplied voltage from the primary coil to the secondary coil; and
delivering the transferred voltage to the powered electrodes.

16. The method of claim 9 wherein electrically isolating further comprises:
direct current isolating the radio-frequency power supply from the plasma chamber.

17. The method of claim 9 further comprising electrically isolating the powered electrodes from the plasma chamber.
